(19) United States
(12) Patent Application Publication
(10) Pub. No.: US 2024/0139861 A1
(43) Pub. Date: May 2, 2024

(54) Ultrasonic Weld Pad

(71) Applicant: Illinois Tool Works Inc., Glenview, IL (US)

(72) Inventors: Kileean E. Bell, Monee, IL (US); Thomas A. Benoit, Bourbonnais, IL (US)

(21) Appl. No.: 18/382,158

(22) Filed: Oct. 20, 2023

Related U.S. Application Data
(60) Provisional application No. 63/420,185, filed on Oct. 28, 2022.

(51) Int. Cl. B23K 20/26; B23K 20/10; B29C 65/08

(52) U.S. Cl. CPC B23K 20/26; B23K 20/106; B29C 65/08

(57) ABSTRACT

Disclosed is a weld pad for an ultrasonic welding system having a sonotrode. For example, a universal weld pad. The weld pad includes a base and a welding component. The base includes an opening to receive an end of the sonotrode. The welding component includes a set of legs and a bridge portion therebetween. The welding component conforms to an outer surface of the weld substrate during a welding operation.

### RELATED APPLICATION

The present application claims priority to U.S. Provisional Patent Application No. 63/420,185, filed Oct. 28, 2022, and entitled “Sonic Weld Pad” which is hereby incorporated by reference in its entirety.

### BACKGROUND

Ultrasonic welding is a solid-state welding process that uses high-frequency mechanical vibrations to join materials together, thus providing strong, hermetically sealed, and aesthetically pleasing welds. Ultrasonic welding is used in industries where strong, reliable, and rapid bonding of plastics and some metals is desired or required, including automotive, electronics, medical devices, packaging, and bonding wires in electronics.

Typically, parts to be welded together to form a weldment are first prepared to ensure that they have clean, flat surfaces with precise mating geometries. In some examples, a weld pad can be welded to a weldment to, for example, secure tubes and/or other components to a fastener or other structure. Existing weld pads, however, are typically designed for specific applications as they are shaped to match the mating geometry of a given substrate. As a result, multiple weld pads are typically needed to accommodate various substrate sizes and/or surface contours. Consequently, requiring multiple weld pads results in multiple part numbers to accommodate multiple applications.

Therefore, despite advancements, a need exists for a universal sonic weld pad designed to work with various surfaces, whether flat, rounded, or uneven.

### SUMMARY

The present disclosure relates generally to an ultrasonic weld pad, substantially as illustrated by and described in connection with at least one of the figures, as set forth more completely in the claims.

### DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 illustrates an example ultrasonic welding system configured to join two or more pieces ultrasonically to form a weldment.

FIG. 2a illustrates a topside isometric view of a weld pad in accordance with a first example.

FIG. 2b illustrates an underside isometric view of the weld pad of FIG. 2a.

FIGS. 2c through 2f illustrate, respectively, first, second, third, and fourth side elevation views of the weld pad of FIG. 2a.

FIG. 2g illustrates a top plan view of the weld pad of FIG. 2a.

FIG. 2h illustrates a bottom plan view of the weld pad of FIG. 2a.

FIG. 2i illustrates a side elevation view of the weld pad prior to clamping with the work piece.

FIG. 2j illustrates a side elevation view of the weld pad securely clamped with the work piece.

FIG. 2k illustrates an isometric view of the weld pad securely clamped with the work piece.

FIG. 3a illustrates a topside isometric view of a weld pad in accordance with a second example.

FIG. 3b illustrates an underside isometric view of the weld pad of FIG. 3a.

FIGS. 3c through 3f illustrate, respectively, first, second, third, and fourth side elevation views of the weld pad of FIG. 3a.

FIG. 3g illustrates a top plan view of the weld pad of FIG. 3a.

FIG. 3h illustrates a bottom plan view of the weld pad of FIG. 3a.

FIG. 4a illustrates a topside isometric view of a weld pad in accordance with a third example.

FIG. 4b illustrates an underside isometric view of the weld pad of FIG. 4a.

FIGS. 4c through 4f illustrate, respectively, first, second, third, and fourth side elevation views of the weld pad of FIG. 4a.

FIG. 4g illustrates a top plan view of the weld pad of FIG. 4a.

FIG. 4h illustrates a bottom plan view of the weld pad of FIG. 4a.

FIG. 4i illustrates an isometric view of the weld pad securely clamped with the work piece.

FIG. 4j illustrates a side elevation view of the weld pad securely clamped with the work piece.

FIG. 5a illustrates a side elevation view of a weld pad in accordance with a fourth example.

FIG. 5b illustrates a side elevation view of a weld pad in accordance with a fifth example.

FIG. 6 illustrates an isometric view of an example tube fastener having tubes secured thereto via weld pads.

FIG. 7 illustrates an example method of ultrasonically welding a weld pad to a weld substrate using an ultrasonic welding system.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

Disclosed is a universal sonic weld pad designed to work with various surfaces, whether flat, rounded, or uneven. In one example, a weld pad for an ultrasonic welding system having a sonotrode comprises: a base having an opening configured to receive a distal end of the sonotrode; and a welding component comprising a set of legs and a bridge portion therebetween. The welding component is configured to conform to an outer surface of a weld substrate during a welding operation.

In another example, a weld pad for an ultrasonic welding system having a sonotrode comprises: a base having an opening configured to receive a distal end of the sonotrode; and a welding component comprising a set of legs and a bridge portion therebetween, wherein the bridge portion is configured to conform to and contact an outer surface of a weld substrate via a plurality of contact regions.

In yet another example, a method for ultrasonically welding a weld pad to a weld substrate to form a weldment using an ultrasonic welding system having a sonotrode and an anvil comprises: sandwiching the weld pad and the weld substrate between the sonotrode and the anvil, the weld pad comprising: a base having an opening configured to receive a distal end of the sonotrode and a welding component comprising a set of legs and a bridge portion therebetween, wherein the welding component is configured to conform to an outer surface of the weld substrate during a welding operation; and applying ultrasonic energy to an interface between the weld pad and the weld substrate via the sonotrode; and ultrasonically welding the weld pad to the weld substrate at the interface.

In some examples, each leg in the set of legs is coupled to the base and configured to flex relative to the base. In some examples, each leg in the set of legs is coupled to the base perpendicularly thereto. In other examples, each leg in the set of legs is coupled to the base and angled toward one another.

In some examples, the bridge portion defines a sonotrode-contact surface and a workpiece-contact surface. The sonotrode-contact surface is configured to contact a sonotrode surface of the sonotrode and the workpiece-contact surface is configured to contact an outer surface of the weld substrate. The workpiece-contact surface defines a plurality of contact regions. In some examples, each of the plurality of contact regions is a linear ridge having a triangular profile. In other examples, each of the plurality of contact regions is a linear ridge having a triangular profile with a flat tip. In yet other examples, each of the plurality of contact regions is pyramidal.

In some examples, the sonotrode-contact surface defines a planar profile, a curved profile, and/or a scalloped profile. In some examples, the bridge portion defines a plurality of windows, which may be formed as a quadrilateral cutout.

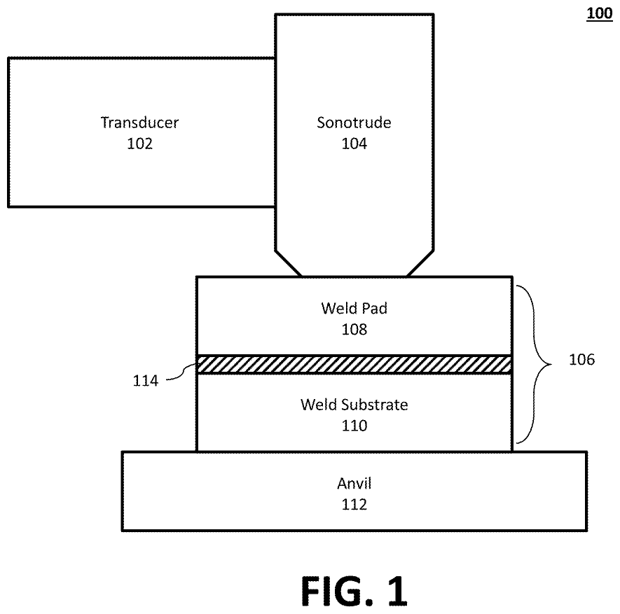

FIG. 1 illustrates an example ultrasonic welding system 100 configured to join two or more pieces of compatible materials ultrasonically to form a weldment 106. Unlike some other welding methods, ultrasonic welding does not require the use of adhesives, solvents, or filler materials. In addition, ultrasonic welding is a clean process that does not produce fumes or emit harmful radiation.

As illustrated, a first welding component and a second welding component are securely clamped between an anvil 112 (sometimes called a fixed horn) and a sonotrode 104 (sometimes called an ultrasonic horn). The first welding component can be a weld pad 108, while the second welding component can be a weld substrate 110, such as tubes, plates, etc.

The anvil 112 supports the stationary part, while the sonotrode 104 is attached to a transducer 102. The ultrasonic transducer 102 generates high-frequency mechanical vibrations, often by using a piezoelectric crystal or magnetostrictive device. The high-frequency mechanical vibrations can be, for example, 20-70 kHz. These vibrations are transmitted through the sonotrode 104 to the materials being welded.

The mechanical vibrations create frictional heat at the interface 114 between the weld pad 108 and the weld substrate 110 to form a weldment 106. With plastics, ultrasonic welding causes localized melting of the plastic at the interface 114 due to absorption of vibration energy. With metals, the high-pressure dispersion of surface oxides and local motion of the materials at the interface 114 results in metal bonding, that is, the vibrations create localized atomic bonding.

As the materials soften or melt, the clamping applies pressure to the weld pad 108 and the weld substrate 110 forcing them to merge and form a weld joint at the interface 114. Compressive forces ensures a strong bond by maintaining contact between the weld pad 108 and the weld substrate 110.

Whereas existing weld pads 108 are typically designed for a particular application, the disclosed weld pad 108 is designed to work with various surfaces, whether flat, rounded, or uneven. As will be described, the disclosed universal weld pads 108 can be embodied in one of multiple examples.

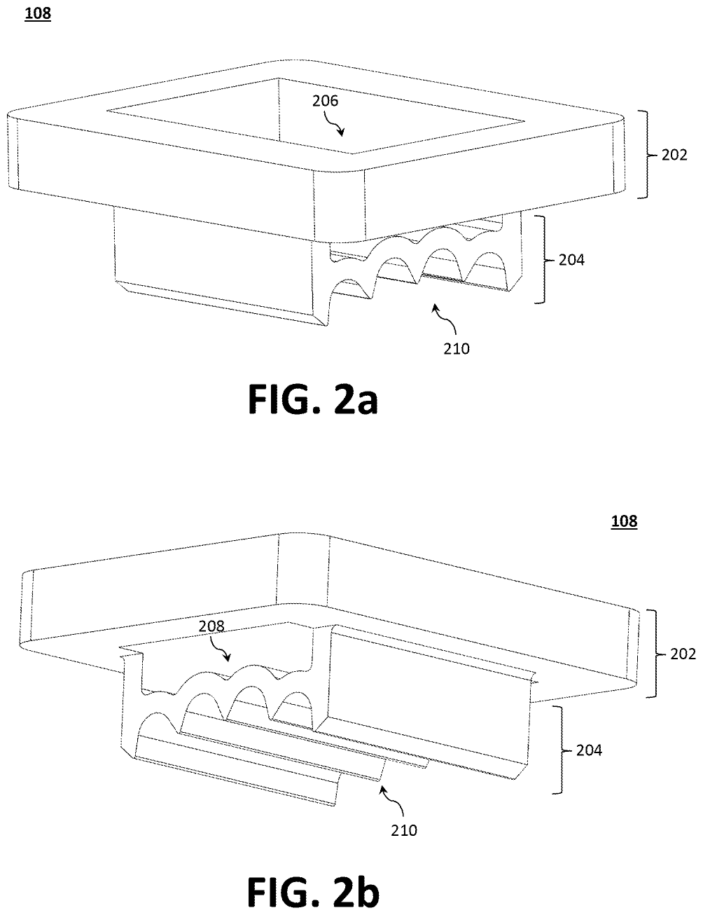

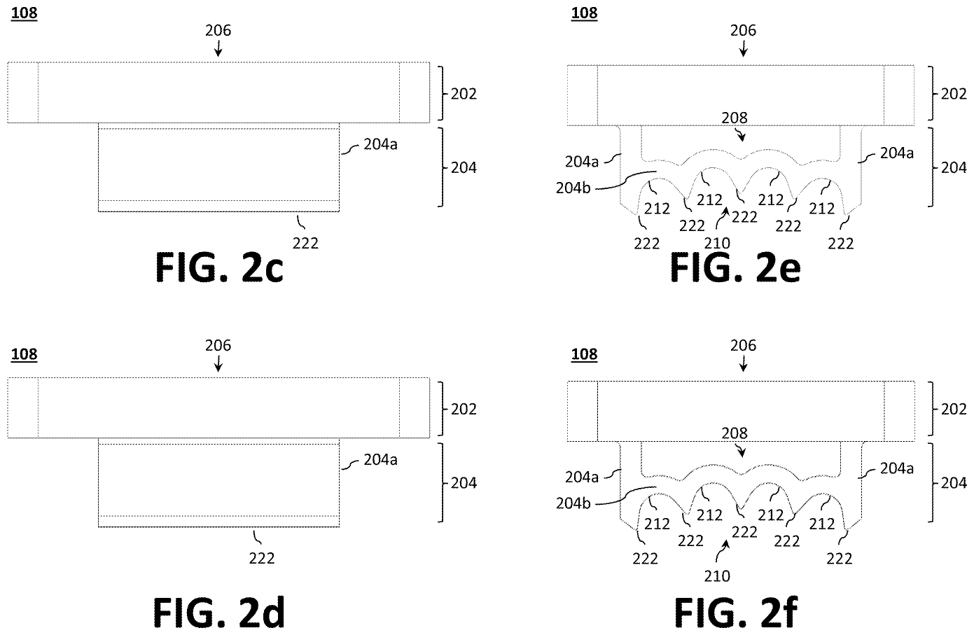

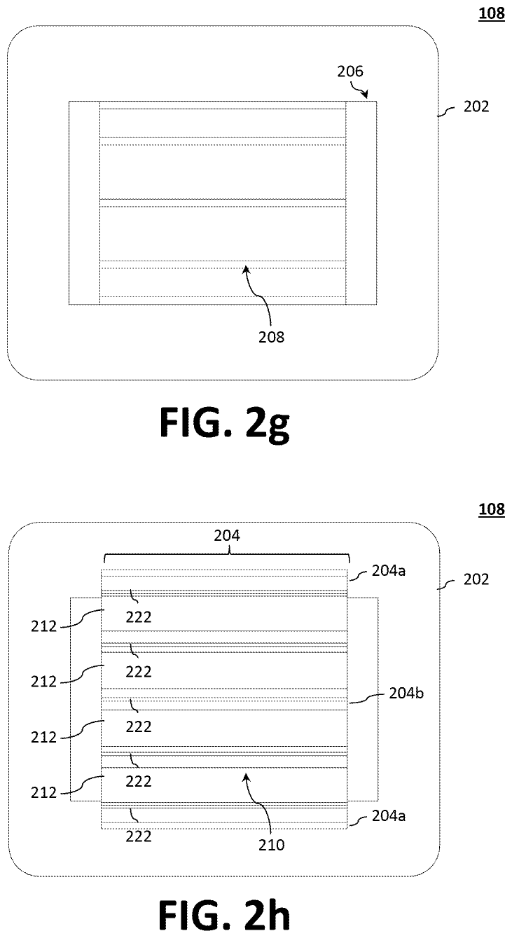

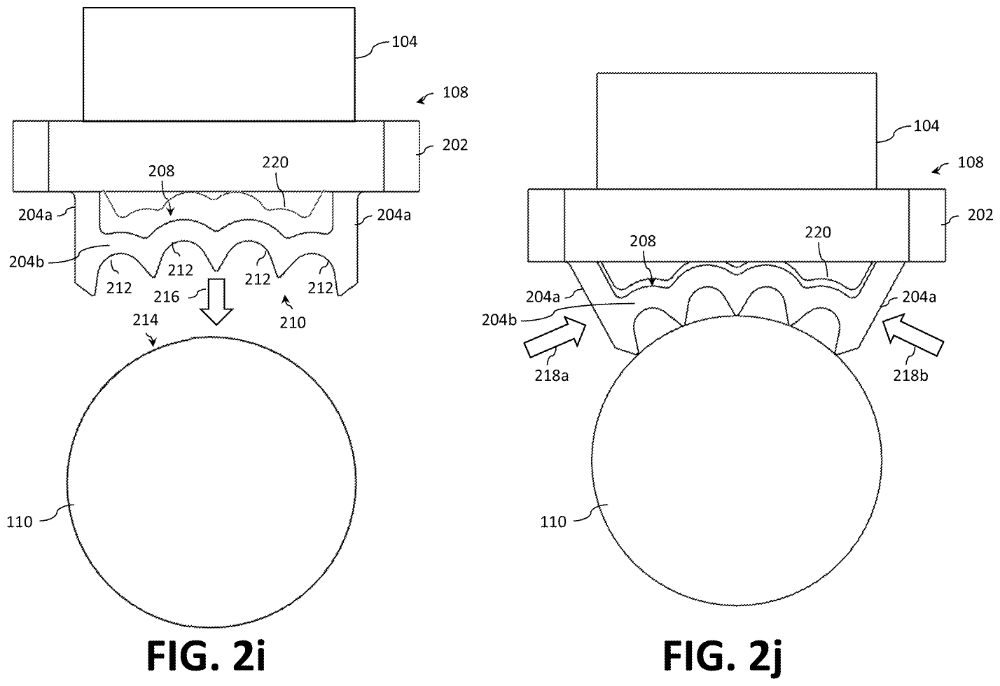

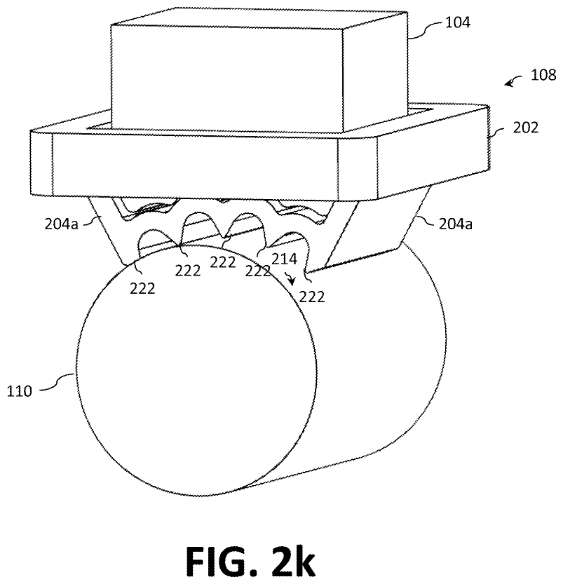

FIGS. 2a and 2b illustrate, respectively, topside and underside isometric views of a weld pad 108 in accordance with a first example. FIGS. 2c through 2f illustrate, respectively, first, second, third, and fourth side elevation views of the weld pad 108 of FIG. 2a. FIGS. 2g and 2h illustrate, respectively, top and bottom plan views of the weld pad 108 of FIG. 2a. FIG. 2i illustrates a side elevation view of the weld pad 108 prior to clamping with the work piece, while FIGS. 2j and 2k illustrate, respectively, side elevation and isometric views of the weld pad 108 securely clamped with the work piece.

The weld pad 108 generally comprises a base 202 and a welding component 204. The base 202 defines an opening 206 configured to receive a distal end of the sonotrode 104. In operation, the sonotrode 104 passes through the opening 206 to contact and, ultimately, clamp the welding component 204 against a weld substrate 110. During a welding operation, the high-frequency mechanical vibrations are transmitted from a sonotrode surface 220 of the sonotrode 104 to the welding component 204 via the opening 206 in the base 202.

The weld pad 108 is designed as a single component configured to deform under the clamping pressure of the sonotrode 104 such that the contact regions 222 formed on the welding component 204 can flex to contact the weld substrate 110 at multiple locations along the interface 114. The weld pad 108 is designed to enable it to be tooled in a simple 2-plate mold or 3D printing application.

The weld pad 108 can be fabricated from, for example, a synthetic or semi-synthetic polymers (e.g., plastics, such as acrylonitrile butadiene styrene (ABS) and polyvinyl chloride (PVC), etc.), composite materials (e.g., fiber glass), or a combination thereof using a plastic injection technique, additive manufacturing, or otherwise. In some examples, the weld pad 108 may be fabricated using material extrusion (e.g., fused deposition modeling (FDM), stereolithography (SLA), selective laser sintering (SLS), material jetting, binder jetting, powder bed fusion, directed energy deposition, VAT photopolymerisation, and/or any other suitable type of additive manufacturing/3D printing process. In other examples, the weld pad 108 may be fabricated from a metal (or a metal alloy).

Additive manufacturing techniques print objects in three dimensions, therefore both the minimum feature size (i.e., resolution) of the X-Y plane (horizontal resolution) and the layer height in Z-axis (vertical resolution) are considered in overall printer resolution. Horizontal resolution is the smallest movement the printer's extruder can make within a layer on the X and the Y axis, while vertical resolution is the minimal thickness of a layer that the printer produces in one pass. Printer resolution describes layer thickness and X-Y resolution in dots per inch (DPI) or micrometers (μm). The particles (3D dots) in the horizontal resolution can be around 50 to 100 μm (510 to 250 DPI) in diameter. Typical layer thickness (vertical resolution) is around 100 μm (250 DPI), although the layers may be as thin as 16 μm (1,600 DPI). The smaller the particles, the higher the horizontal resolution (i.e., higher the details the printer produces). Similarly, the smaller the layer thickness in Z-axis, the higher the vertical resolution (i.e., the smoother the printed surface will be). A printing process in a higher vertical resolution printing, however, will take longer to produce finer layers as the printer has to produce more layers. In some examples, portions of the weld pad 108 may be formed or otherwise fabricated at different resolutions during a printing operation.

In the illustrated example, the welding component 204 generally comprises a set of legs 204a, each of which being coupled to the base 202 resiliently at a proximal end thereof. As illustrated, the set of legs 204a are spaced apart and configured to project away from the base 202 perpendicularly. A bridge portion 204b joins the distal ends of the set of legs 204a to one another.

The bridge portion 204b defines a sonotrode-contact surface 208 and a workpiece-contact surface 210. The sonotrode-contact surface 208 is configured to contact the sonotrode surface 220 at the distal end of the sonotrode 104, while the workpiece-contact surface 210 is configured to contact an outer surface 214 of the weld substrate 110. The workpiece-contact surface 210 and the outer surface 214 form or otherwise define the interface 114 between the weld pad 108 and the weld substrate 110.

The workpiece-contact surface 210 is shaped to define the one or more contact regions 222. In the illustrated example, the one or more contact regions 222 are linear ridges that span the workpiece-contact surface 210 linearly. As best illustrated in FIGS. 2e and 2f, the profile of the workpiece-contact surface 210 is shaped to define a scalloped profile whereby adjacent contact regions 222 are separated by a channel 212. The channel 212, in addition to defining the linear contact regions 222, increases flexibility of the bridge portion 204b.

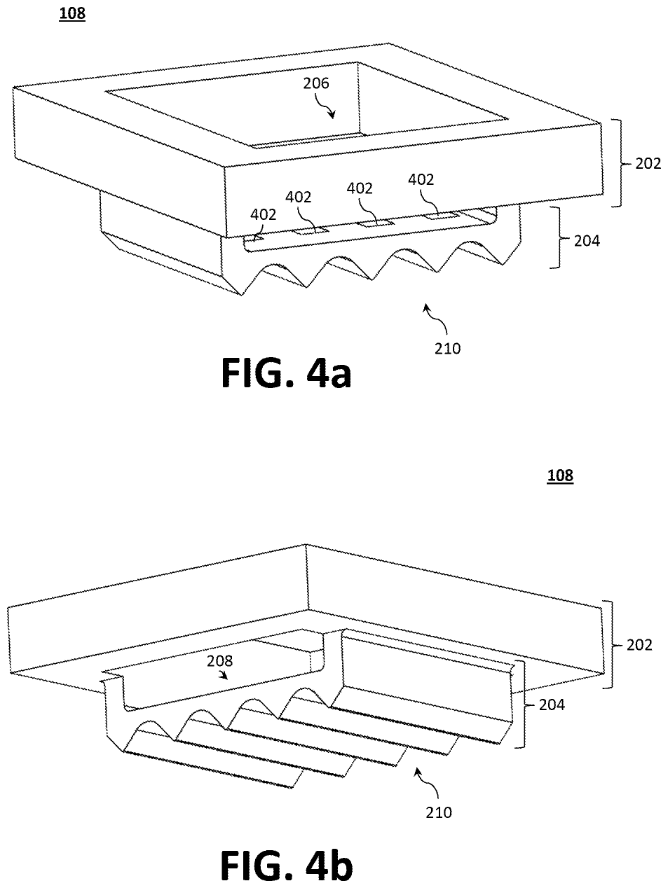

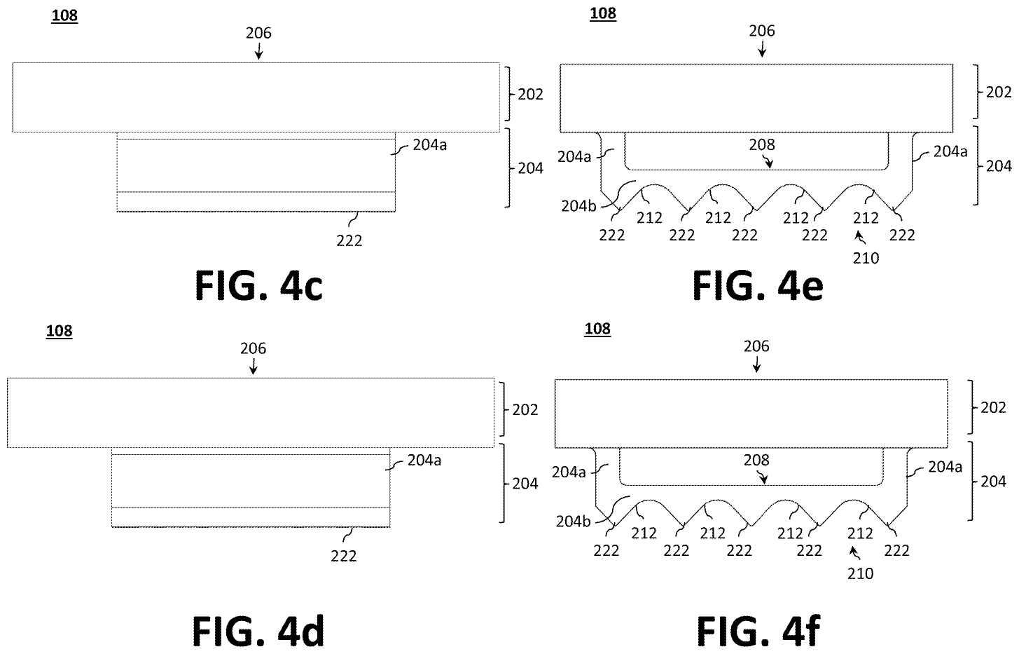

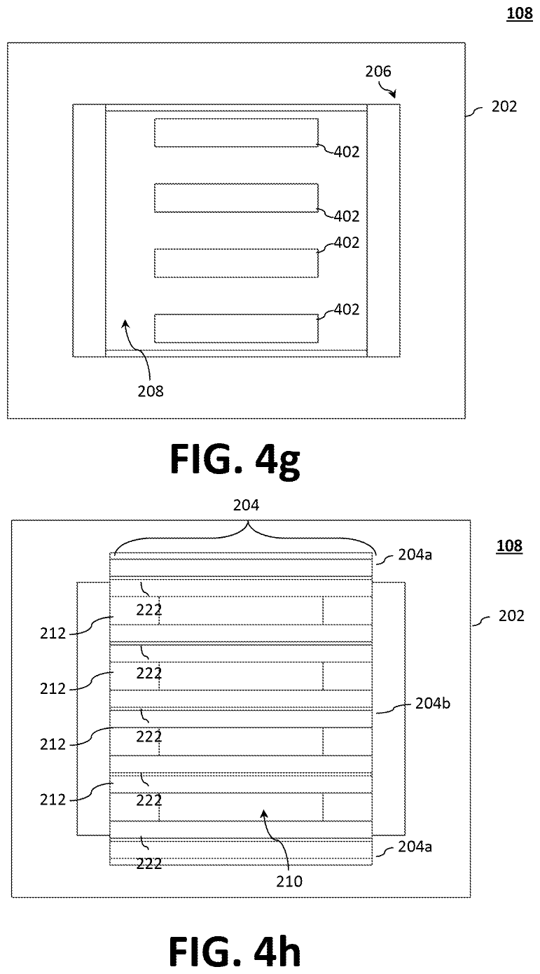

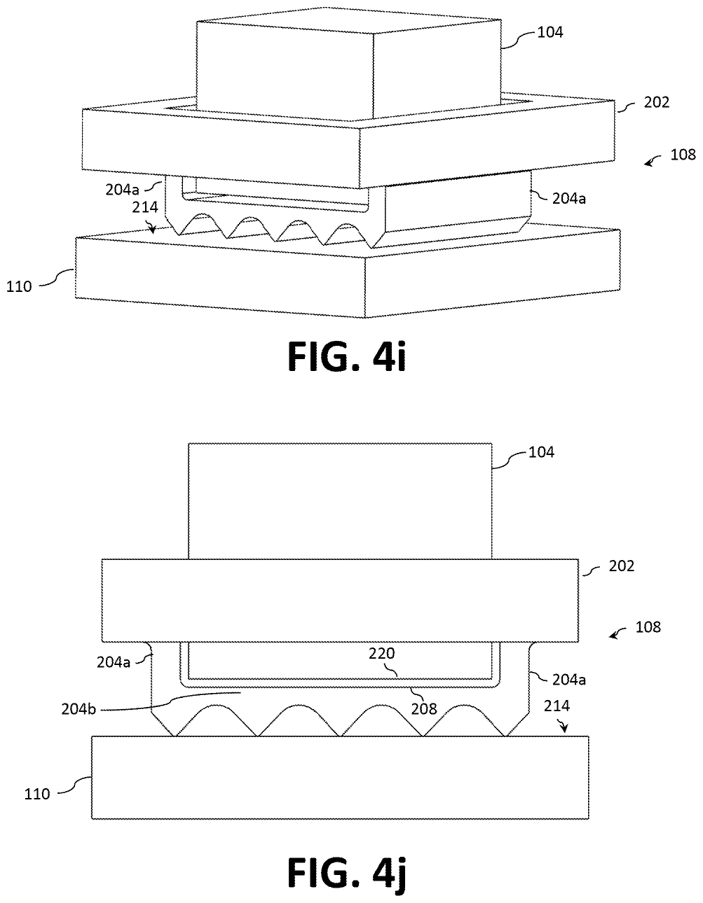

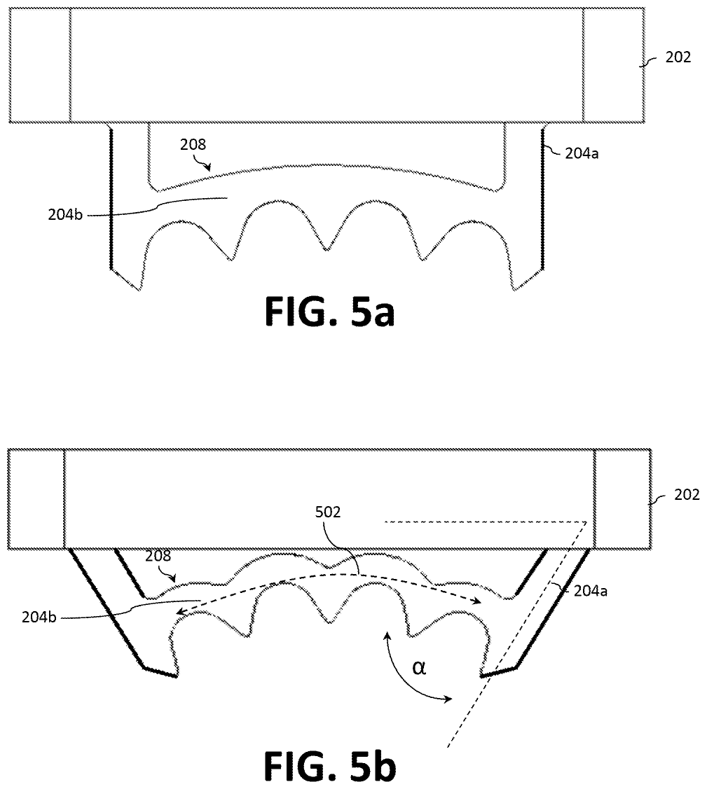

In the illustrated example, each of the sonotrode-contact surface 208 and the workpiece-contact surface 210 is shaped to define a curved scalloped profile. A non-planar profile, such as a curved scalloped profile, can increase flexibly of the bridge portion 204b during compression. While the sonotrode-contact surface 208 and the workpiece-contact surface 210 are illustrated as defining a curved scalloped profile and the contact regions 222 are illustrated as linear ridges and having a triangular profile with a sharp edge, other profiles and shapes are contemplated. For example, the profiles of the sonotrode-contact surface 208 and/or the workpiece-contact surface 210 maybe angular (e.g., triangular), smooth curved (an example of which is illustrated in FIG. 5a), or even linear (an example of which is described in connection with FIGS. 4a through 4j). In another example, the contact regions 222 are pyramid-shaped (e.g., arranged as a string of pyramidal contact regions 222), linear and having a triangular profile with a flat top, or otherwise.

The set of legs 204a, in effect, served as hinges or flex points to make the welding component 204 more flexible at the workpiece-contact surface 210. As best illustrated in FIGS. 2i and 2j, the set of legs 204a and the bridge portion 204b are configured to deform when clamped (e.g., between the sonotrode 104 and the anvil 112) so that its contact regions 222 make intimate contact the weld substrate 110 at multiple locations along the interface 114. That is, during a welding, when the weld pad 108 is urged toward the weld substrate 110 (as indicated by Arrow 216) and subject to clamping pressure between the sonotrode 104 and anvil 112, the set of legs 204a flex toward one another (as indicated by Arrows 218a, 218b) and the bridge portion 204b curves or flexes to conform to the outer surface 214 of the weld substrate 110.

The sonotrode surface 220 can also be shaped to help shape (e.g., flex or bend) the bridge portion 204b such that the workpiece-contact surface 210 conforms to the shape of the outer surface 214 of the weld substrate 110. In some examples, an example of which is illustrated in FIGS. 2i and 2j, the sonotrode surface 220 of the sonotrode 104 is shaped to define a desired profile for the sonotrode-contact surface 208 when clamped. In the illustrated example, the sonotrode surface 220 is shaped to define a scalloped profile the compliments the profile of the sonotrode-contact surface 208 when clamped.

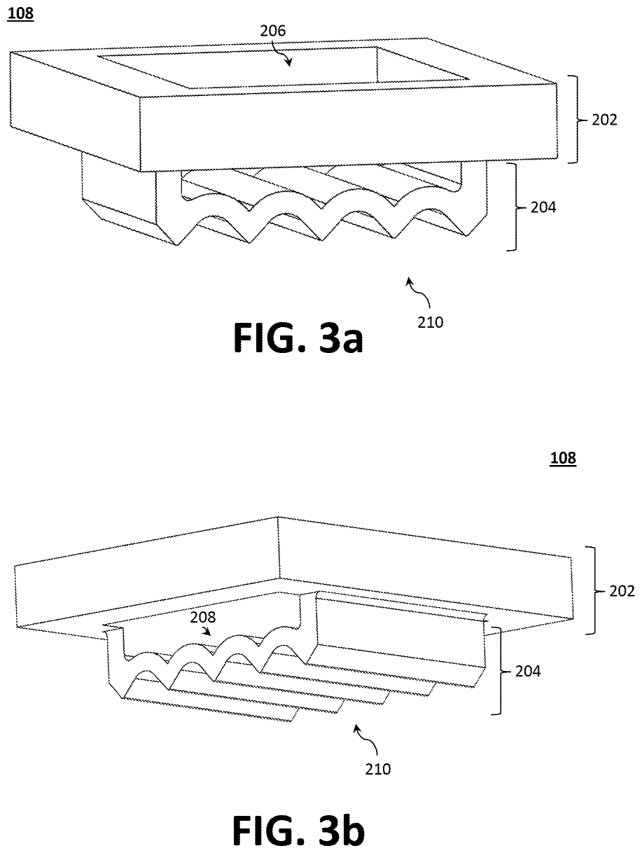

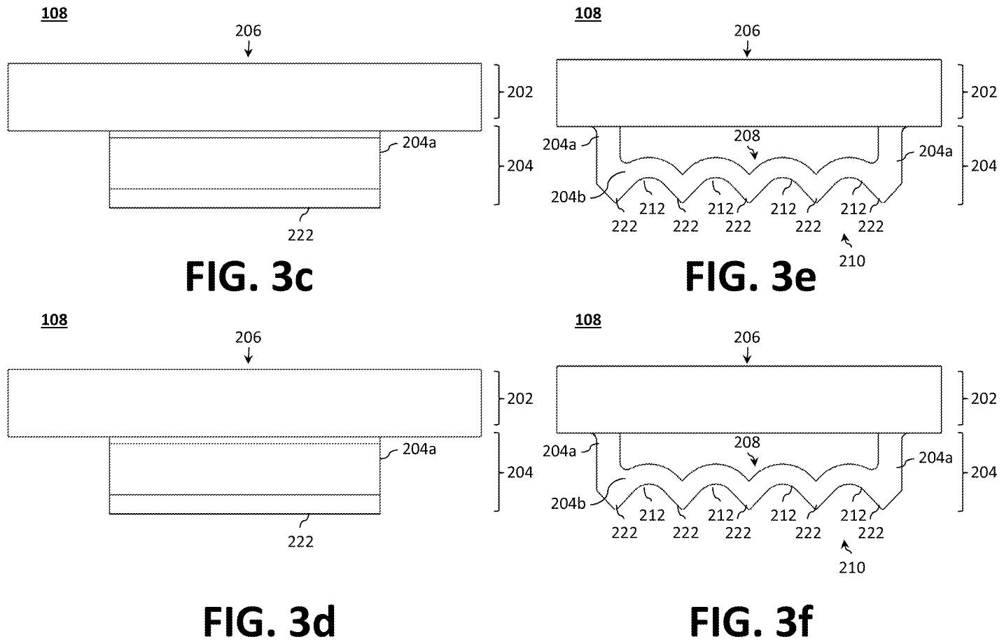

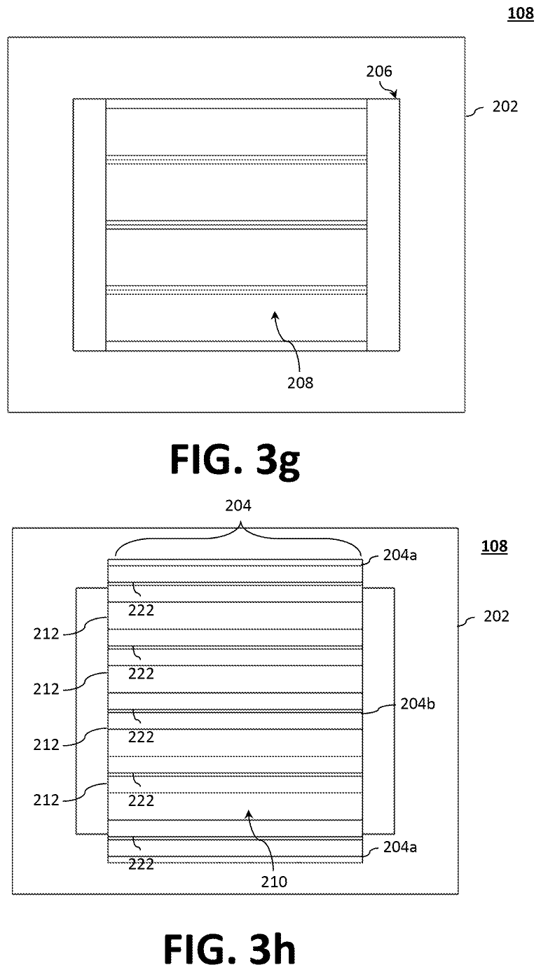

FIGS. 3a and 3b illustrate, respectively, topside and underside isometric views of a weld pad 108 in accordance with a second example. FIGS. 3c through 3f illustrate, respectively, first, second, third, and fourth side elevation views of the weld pad 108 of FIG. 3a. FIGS. 3g and 3h illustrate, respectively, top and bottom plan views of the weld pad 108 of FIG. 3a.

The weld pad 108 according to the second example of FIGS. 3a through 3h is substantially the same as the weld pad 108 according to the first example of FIGS. 2a through 2k except that the curvature of the bridge portion 204b is reduced such that it is scalloped, but generally linear or substantially linear. While the curved bridge portion 204b of FIGS. 2a through 2k may be suitable for weld substrate 110 having an outer surface 214 with a meaningful curvature (e.g., smaller tubes), a linear or less-curved bridge portion 204b would be more suitable for weld substrates 110 that do not exhibit an outer surface 214 with a meaningful curvature (e.g., larger-diameter tubes and/or flat components).

FIGS. 4a and 4b illustrate, respectively, topside and underside isometric views of a weld pad 108 in accordance with a third example. FIGS. 4c through 4f illustrate, respectively, first, second, third, and fourth side elevation views of the weld pad 108 of FIG. 4a. FIGS. 4g and 4h illustrate, respectively, top and bottom plan views of the weld pad 108 of FIG. 4a.

The weld pad 108 according to the third example of FIGS. 4a through 4j is substantially the same as the weld pad 108 according to the second example of FIGS. 3a through 3h with certain exception. First, the profile of the sonotrode-contact surface 208 in this example is planar (rather than curved or curved and scalloped, for example) and configured to compliment and/or contact a sonotrode surface 220 of the sonotrode 104a that is similarly planar. Second, the weld pad 108 includes a plurality of windows 402 formed in the bridge portion 204b. Each of the illustrated plurality of windows 402 is formed as a quadrilateral cutout (e.g., a rectangle); however, other shapes are contemplated, such as circles, ovals, triangles, linear slits, etc. The plurality of windows 402 serve to increase flexibility of the bridge portion 204b by slicing and/or removing material from the structure of the bridge portion 204b positioned between the set of legs 204a. The plurality of windows 402 can also be employed in the other example weld pads 108 described herein.

FIG. 5a illustrates a side elevation view of a weld pad 108 in accordance with a fourth example. The weld pad 108 according to the fourth example of FIG. 5a is substantially the same as the weld pad 108 according to the first example of FIGS. 2a through 2k except that the profile of the sonotrode-contact surface 208 in this example is smooth curved (rather than curved and scalloped, for example).

FIG. 5b illustrates a side elevation view of a weld pad 108 in accordance with a fifth example. The weld pad 108 according to the fifth example of FIG. 5b is substantially the same as the weld pad 108 according to the first example of FIGS. 2a through 2k except that the weld pad 108 is pre-contoured.

In some examples, the weld pad 108 (or a portion thereof, such as the bridge portion 204b) can be formed in a pre-contoured position to ease or reduce the amount the weld pad 108 needs to flex to contact the outer surface 214 of the weld substrate 110. That is, pre-contouring the weld pad 108 may be beneficial when the weld pad 108 is expected to be used with a category of weld substrates 110 having more a common characteristic. For example, weld substrates 110 configured as tubes, while not necessarily identical in terms of curvature, size, or shape, would typically exhibit an outer profile that is curved.

To that end, the set of legs 204a and the bridge portion 204b can be pre-contoured or pre-shaped to an extent, thus easing or reducing the amount the weld pad 108 needs to flex when clamped. In the case of weld substrates 110 configured as tubes, for example, the set of legs 204a need not be perpendicular to the base 202, but instead, the set of legs 204a can be angled toward one another relative to the base 202 at Angle α (prior to being subjected to clamping) to better match the expected shape when subject to clamping (e.g., as illustrated in FIG. 2j). Similarly, the curvature 502 of the bridge portion 204b can be increased to better match the expected shape when subject to clamping.

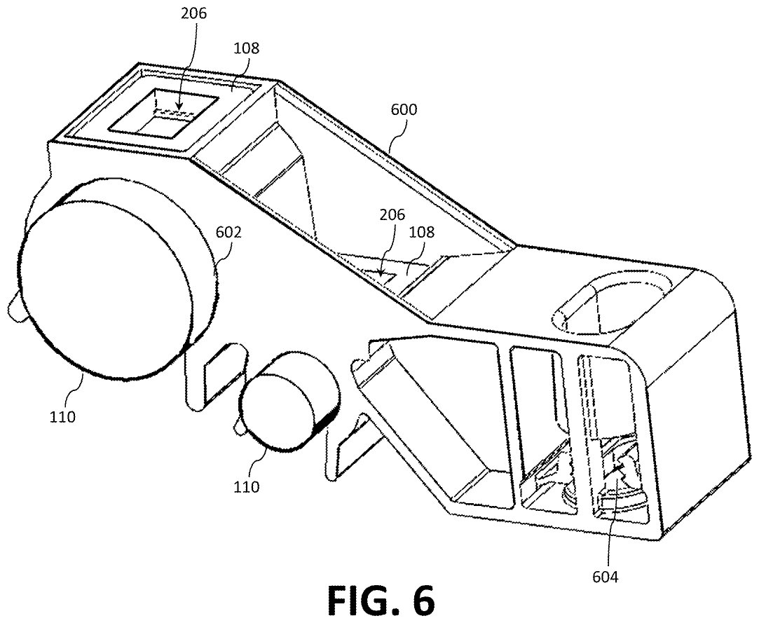

FIG. 6 illustrates an isometric view of an example tube fastener 600 having tube-shaped weld substrates 110 secured thereto via weld pads 108. The tube fastener 600 can be fabricated from a synthetic or semi-synthetic polymers (e.g., plastics, such as acrylonitrile butadiene styrene (ABS) and polyvinyl chloride (PVC), etc.), composite materials (e.g., fiber glass), or a combination thereof using a plastic injection technique, additive manufacturing, or otherwise.

The tube fastener 600 may include, define, or otherwise provide a plurality of pockets 602 and a fastener 604. The tube fastener 600 is configured to couple with and/or secure the tube-shaped weld substrates 110 relative to one another and, ultimately, another component (e.g., a vehicle component, such as a frame or similar structure) via the fastener 604. Each of the plurality of pockets 602 is configured to secure a tube-shaped weld substrate 110. As illustrated, each of the plurality of pockets 602 can be shaped as a channel that generally corresponds to the diameter of the tube-shaped weld substrates 110.

A weld substrate 110 with a curved outer surface 214 (e.g., a tube-shaped weld substrate) can be inserted into and secured within each of the plurality of pockets 602 by pushing the tube-shaped weld substrate 110 toward the respective tube pocket 602. While two pockets 602 are illustrated, additional or fewer pockets 602 may be provided depending on the design needs (e.g., the number of tube-shaped weld substrates 110 that need to be secured). Once a tube-shaped weld substrate 110 is positioned in its respective tube pocket 602, a weld pad 108 is positioned adjacent the tube-shaped weld substrate 110 and welded to a portion of the tube-shaped weld substrate 110 (e.g., at the outer surface 214) via an opening formed in the tube fastener 600. As a result, the tube-shaped weld substrates 110 is secured relative to the tube pocket 602 via both the pocket 602 and the weld pad 108.

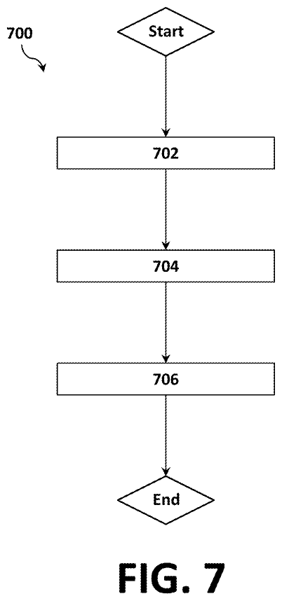

FIG. 7 illustrates an example method 700 of ultrasonically welding a weld pad 108 to a weld substrate 110 using an ultrasonic welding system 100 having a sonotrode 104 and an anvil 112.

At step 702, the weld pad 108 and the weld substrate 110 are sandwiched or otherwise positioned between the sonotrode 104 and the anvil 112. For example, the weld pad 108 and the weld substrate 110 can be positioned in fastener and then clamped between the sonotrode 104 and the anvil 112.

At step 704, ultrasonic energy is applied to the interface 114 between the weld pad 108 and the weld substrate 110 via the sonotrode 104.

At step 706, the weld pad 108 is ultrasonically welded to the weld substrate 110 at the interface 114.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed is:

1. A weld pad for an ultrasonic welding system having a sonotrode, the weld pad comprising:
a base having an opening configured to receive a distal end of the sonotrode; and a welding component comprising a set of legs and a bridge portion therebetween,
wherein the welding component is configured to conform to an outer surface of a weld substrate during a welding operation.

2. The weld pad of claim 1, wherein each leg in the set of legs is coupled to the base and configured to flex relative to the base.

3. The weld pad of claim 1, wherein each leg in the set of legs is coupled to the base perpendicularly thereto.

4. The weld pad of claim 1, wherein each leg in the set of legs is coupled to the base and angled toward one another.

5. The weld pad of claim 1, wherein weld pad of claim 1, wherein the bridge portion defines a sonotrode-contact surface and a workpiece-contact surface.

6. The weld pad of claim 5, wherein the sonotrode-contact surface is configured to contact a sonotrode surface of the sonotrode and the workpiece-contact surface is configured to contact an outer surface of the weld substrate.

7. The weld pad of claim 6, wherein the workpiece-contact surface defines a plurality of contact regions.

8. The weld pad of claim 7, wherein each of the plurality of contact regions is a linear ridge having a triangular profile.

9. The weld pad of claim 7, wherein each of the plurality of contact regions is a linear ridge having a triangular profile with a flat tip.

10. The weld pad of claim 7, wherein each of the plurality of contact regions is pyramidal.

11. The weld pad of claim 6, wherein the sonotrode-contact surface defines a planar profile.

12. The weld pad of claim 6, wherein the sonotrode-contact surface defines a curved profile.

13. The weld pad of claim 6, wherein the sonotrode-contact surface defines a scalloped profile.

14. The weld pad of claim 1, wherein the bridge portion defines a plurality of windows.

15. The weld pad of claim 14, wherein each of the plurality of windows is formed as a quadrilateral cutout.

16. A method for ultrasonically welding a weld pad to a weld substrate to form a weldment using an ultrasonic welding system having a sonotrode and an anvil, the method comprising:
sandwiching the weld pad and the weld substrate between the sonotrode and the anvil, the weld pad comprising:
a base having an opening configured to receive a distal end of the sonotrode and
a welding component comprising a set of legs and a bridge portion therebetween,
wherein the welding component is configured to conform to an outer surface of the weld substrate during a welding operation; and
applying ultrasonic energy to an interface between the weld pad and the weld substrate via the sonotrode; and
ultrasonically welding the weld pad to the weld substrate at the interface.

17. A weldment fabricated in accordance with the method of claim 16.

18. A weld pad for an ultrasonic welding system having a sonotrode, the weld pad comprising:
a base having an opening configured to receive a distal end of the sonotrode; and
a welding component comprising a set of legs and a bridge portion therebetween,
wherein the bridge portion is configured to conform to and contact an outer surface of a weld substrate via a plurality of contact regions.

19. The weld pad of claim 18, wherein weld pad of claim 1, wherein the bridge portion defines a sonotrode-contact surface configured to contact a sonotrode surface of the sonotrode and a workpiece-contact surface configured to contact the outer surface of the weld substrate.

20. The weld pad of claim 18, wherein the bridge portion defines a plurality of windows, wherein each of the plurality of windows is formed as a quadrilateral cutout.
